(19) United States
(12) Patent Application Publication
(10) Pub. No.: US 2006/0273592 A1
(43) Pub. Date: Dec. 7, 2006

(54) Power unit

(75) Inventors: Hiroshi Yamabuchi, Tokyo (JP); Yuji Kuramoto, Tokyo (JP); Toru Kimura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 11/445,253

(22) Filed: Jun. 2, 2006

(30) Foreign Application Priority Data
Jun. 6, 2005 (JP) JP2005-165397

(51) Int. Cl. H02P 9/04

(52) U.S. Cl. 290/40 C

(57) ABSTRACT

A power unit includes a plurality of power modules for controlling individual phases of a pair of rotating electric machines and a heat sink on which the power modules are mounted. Each of the power modules includes a metal block, four power electronic semiconductor devices which are heat-generating elements mounted on the metal block with electrically conductive device bonding layers placed in between, and a plastic case. The plastic case is made of a plastic material sealing the power electronic semiconductor devices and the metal block in a single package with leads connected to top- and bottom-side electrodes of the power electronic semiconductor devices extending outward from the plastic case.

### BACKGROUND OF THE INVENTION

1. Field of the Invention

The present invention relates generally to a power unit used as a power converter for controllably driving an electric motor or a generator mounted on a mobile unit, such as a motor vehicle, and more particularly, to a power unit including power modules which incorporate power electronic semiconductor devices.

2. Description of the Background Art

Hybrid vehicles have recently been marketed in automotive industry. The hybrid vehicles are typically equipped with a power converter which converts direct current (DC) power fed from an onboard battery into alternating current (AC) power to drive a motor and converts AC power produced by transforming kinetic energy into electrical energy by a generator during braking into DC power to charge the battery.

As an example, Japanese Patent Application Publication No. 2003-204606 discloses a conventional hybrid vehicle provided with a pair of rotating electric machines each of which can be operated either as a motor or as a generator. The two rotating electric machines are individually connected to semiconductor inverters which serve as driving circuits of the respective rotating electric machines. The amount of electric power generated by the generator and the amount of motive power produced by the motor are controlled by turning on and off switching devices of each of the inverters which are interconnected by a common power line.

The aforementioned inverters (i.e., power converters) for controllably switching the two rotating electric machines between power running mode (motor mode) and regenerative running mode (generator mode) each employ a circuit configuration which includes as a minimum functional unit a pair of power electronic semiconductor devices, that is, an insulated-gate bipolar transistor (IGBT) and a freewheeling diode. This circuit configuration includes two such semiconductor device pairs which control flows of electric current in the power running mode and the regenerative running mode in different ways independently of each other. For controlling the two rotating electric machines which serve as three-phase motor-generators, a total of six minimum functional units (or six semiconductor device pairs) are required. In the aforementioned conventional hybrid vehicle, six semiconductor device pairs are packaged in a plastic power module by insert molding and this power module is mounted on a heat sink, forming a power unit of the vehicle.

In the aforementioned power unit of the conventional hybrid vehicle, six power electronic semiconductor units constituting two power converters are packaged in a single power module as mentioned above. Therefore, even when only one of the power electronic semiconductor devices fails, it is necessary to replace the complete power module including even the properly working semiconductor devices, resulting in an economic loss.

Additionally, a plastic case of the power module incorporating the six power electronic semiconductor units is so large-sized that deformation or a crack tends to occur in the plastic case due to a difference in linear expansion coefficient between different materials of conductors carrying the electric power and the plastic case. A further problem of the above-described prior art configuration is that it is difficult to arrange and fix the conductors at specified positions to form a much complicated conductor pattern in a short time during an insert molding process.

### SUMMARY OF THE INVENTION

Intended to overcome the aforementioned problems of the prior art, it is an object of the invention to provide an economical power unit with a reduced number of components which need to be replaced and disposed of in case of a failure of any power electronic semiconductor device. It is another object of the invention to provide an easy-to-manufacture module-type power unit which offers excellent mechanical durability and less potential for the occurrence of deformation or a crack in a plastic package.

In one feature of the invention, a power unit used as a power converter for controllably driving a plurality of rotating electric machines which are switchable between motor mode and generator mode includes a plurality of power modules for controlling individual phases of the plurality of rotating electric machines, and a heat sink on which the power modules are mounted. Each of the power modules includes a plurality of power electronic semiconductor devices, each having electrodes on top and bottom sides thereof, a metal block disposed on the bottom side of the power electronic semiconductor devices, electrically conductive device bonding layers disposed between the bottom-side electrodes of the power electronic semiconductor devices and the metal block in direct contact therewith, bottom-side electrode leads connected to the bottom-side electrodes of the respective power electronic semiconductor devices, top-side electrode leads connected to the top-side electrodes of the respective power electronic semiconductor devices, and a sealing plastic body sealing the metal block and the power electronic semiconductor devices with the bottom-side electrode leads and the top-side electrode leads extending outward from the sealing plastic body.

Each of the power modules of this power unit is structured by mounting the power electronic semiconductor devices on the metal block with the electrically conductive device bonding layers placed in between and sealing the metal block and the power electronic semiconductor devices in a plastic case with the top- and bottom-side electrode leads extending outward from the package. This structure makes it possible to produce compact yet high-capacity power modules featuring improved heat dissipating performance. According to this structure of the invention, it is possible to manufacture a power unit provided with compact power modules for controlling individual phases of a plurality of rotating electric machines with high reliability, the power modules being mounted on a heat sink. A reduction in size of each power module serves to prevent the occurrence of deformation and cracks in the plastic case thereof.

Additionally, since the multiple power modules are provided for controlling the individual phases of each rotating electric machine, it is possible to reduce the number of components, and in particular expensive components like power electronic semiconductor devices, that should be replaced and disposed of in case of a failure, thus providing an economic advantage.

In another feature of the invention, a power unit used as a power converter for controllably driving a plurality of rotating electric machines which are switchable between motor mode and generator mode includes a plurality of power modules for controlling individual phases of the plurality of rotating electric machines, each of the power modules including a plurality of power electronic semiconductor devices, a heat sink on which the power modules are mounted, and a terminal block in which conductors are embedded. In this power unit, at least three of the power modules are arranged side by side with three main terminals of each of the at least three power modules aligned in one direction, and the main terminals of the power modules arranged side by side are connected to the conductors of the terminal block.

Since the multiple power modules are provided for controlling the individual phases of each rotating electric machine in this power unit of the invention, it is possible to reduce the number of components, and in particular expensive components like power electronic semiconductor devices, that should be replaced and disposed of in case of a failure, thus providing an economic advantage. Also, a reduction in size of each power module serves to prevent the occurrence of deformation and cracks in the plastic case thereof. According to this structure of the invention, it is possible to assemble each power module in a short time by a simple process, so that a plurality of power modules can be simultaneously manufactured with ease.

Furthermore, the power unit can be manufactured by a simple process as at least three power modules are arranged side by side with the three main terminals of each of the three power modules aligned in one direction and connected to the conductors embedded in the terminal block. Additionally, as the terminal block is provided as a discrete component separate from the power modules, the power unit has excellent mechanical durability.

These and other objects, features and advantages of the invention will become more apparent upon reading the following detailed description in conjunction with the accompanying drawings.

### BRIEF DESCRIPTION OF THE DRAWINGS

FIG. 1 is a circuit diagram showing an internal circuit configuration of a power unit according to a first embodiment of the invention;

FIG. 2 is a plan view of the power unit of the first embodiment showing in particular an arrangement of constituent components thereof;

FIG. 3 is a plan view of one power module of the power unit of the first embodiment;

FIG. 4A is a cross-sectional view showing an internal configuration of the power module of the power unit of the first embodiment taken along lines A-A of FIG. 3;

FIG. 4B is a cross-sectional view showing the internal configuration of the power module of the power unit of the first embodiment taken along lines B-B of FIG. 3;

FIG. 5 is a plan view of a power unit according to a second embodiment of the invention showing in particular an arrangement of constituent components thereof;

FIG. 6 is a circuit diagram showing an internal circuit configuration of a power unit according to a third embodiment of the invention; and

FIG. 7 is a plan view of the power unit of the third embodiment showing in particular an arrangement of constituent components thereof.

### DESCRIPTION OF THE PREFERRED EMBODIMENTS

### First Embodiment

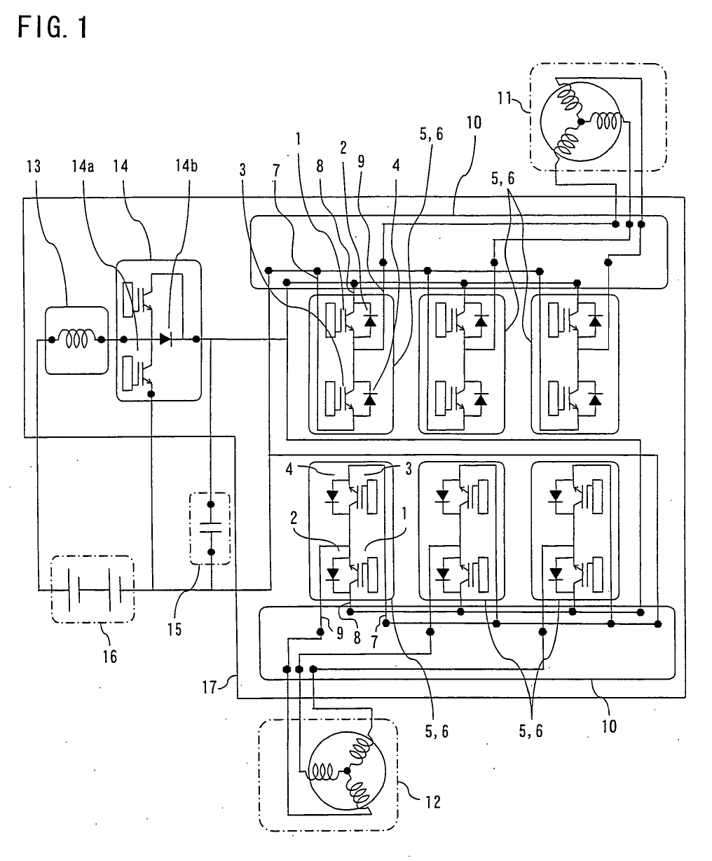

A power unit mounted on a hybrid vehicle according to a first embodiment of the present invention is described with reference to FIGS. 1 to 3.

Generally, a hybrid vehicle is equipped with a power converter which works as an inverter for converting DC power fed from an onboard battery into AC power to drive a motor and as a converter (rectifier) for converting AC power produced by transforming kinetic energy of the vehicle into electrical energy by a generator during braking into DC power to charge the battery. In this embodiment, the hybrid vehicle is provided with a pair of rotating electric machines 11, 12 each of which can be operated either as a motor or as a generator. In one form of the invention, one of these rotating electric machines 11, 12 is run as a motor while the other is run as a generator. In another form of the invention, both of the rotating electric machines 11, 12 are operated as motors or as generators at the same time. This kind of rotating electric machines are conventionally operated in this way in a controlled fashion by a module-type power converter, or a power module, incorporating power electronic semiconductor devices. This power module is mounted on a heat sink to form the power unit of the embodiment.

FIG. 1 is a circuit diagram showing an internal circuit configuration of the power unit according to the first embodiment of the invention for controllably driving the two rotating electric machines 11, 12 each of which can be operated either as a motor or as a generator when switched between power running mode (motor mode) and regenerative running mode (generator mode).

Referring to FIG. 1, the power unit includes a total of six power electronic semiconductor units 5 each of which serves as a minimum functional unit for controlling operation in the power running mode and the regenerative running mode, each power electronic semiconductor unit 5 incorporating a pair of power electronic semiconductor devices, that is, an IGBT 1 and a freewheeling diode 2, or an IGBT 3 and a freewheeling diode 4. The power electronic semiconductor devices 1-4 of each power electronic semiconductor unit 5 are assembled and sealed in a single plastic package to form a power module 6.

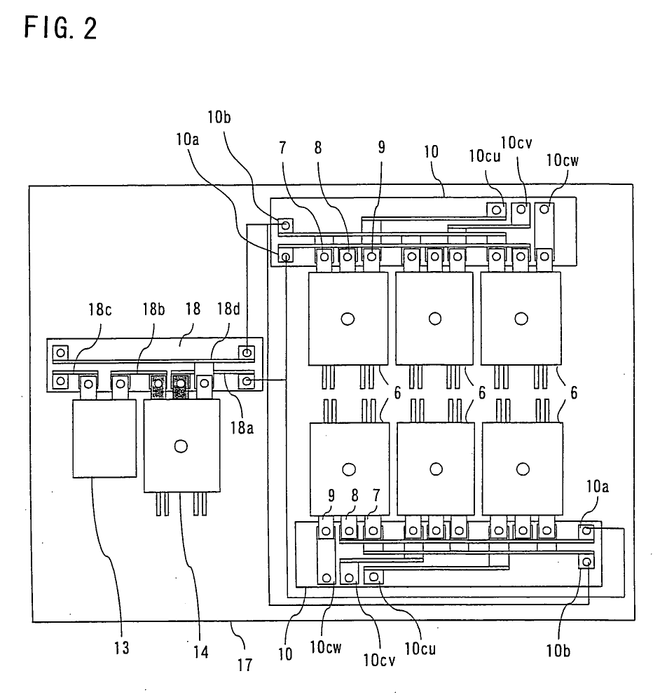

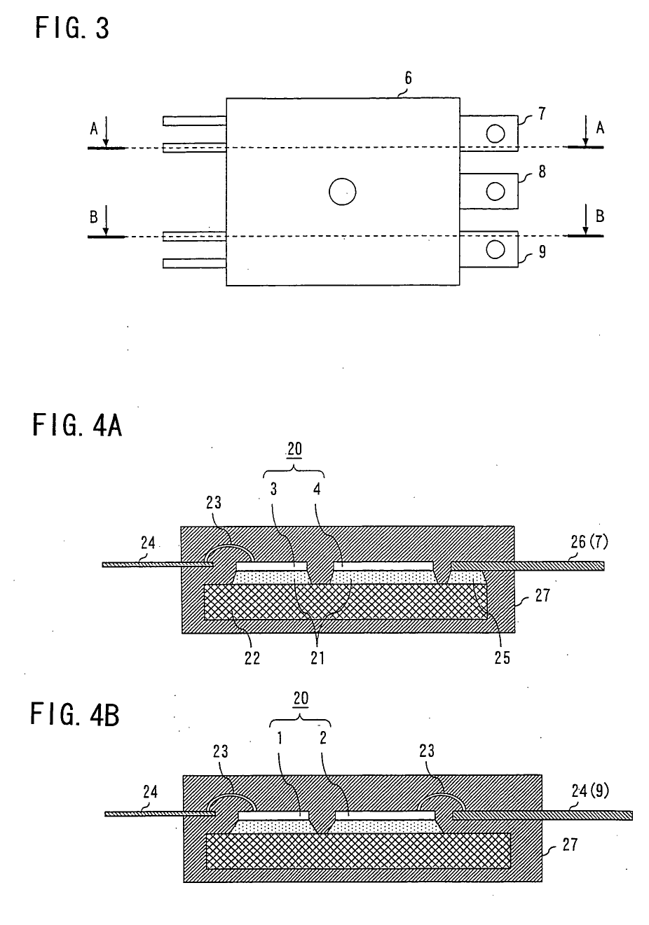

Main terminals 7, 8, 9 for carrying electric currents to and from the power modules 6 extend from one side of each of the power modules 6 as shown in FIG. 3. Three of the six power modules 6 are arranged side by side with the main terminals 7, 8, 9 thereof aligned in one direction and joined to a terminal block 10, while the other three power modules 6 are arranged side by side with the main terminals 7, 8, 9 thereof aligned in the opposite direction and joined to another terminal block 10 as shown in FIG. 2. Here, the main terminals 7 are negative electrode (N-side) terminals, the main terminals 8 are positive electrode (P-side) terminals and the main terminals 9 are rotating-machine-side terminals. Each terminal block 10 has built-in conductors through which the rotating-machine-side terminals 9 are connected to ends of three-phase field coils (U-, V- and W-phases) of one of the rotating electric machines 11, 12.

The power unit of the embodiment further includes a DC-DC converter including an inductor 13 made of a coil or a transformer and a power module 14 in which high-frequency switches (e.g., IGBTs) 14a and a commutating diode 14b are assembled in a single package. The DC-DC converter and the six power modules 6 are connected to the two terminal blocks 10 which are together mounted on a heat sink 17.

Designated by the reference numerals 15 and 16 in FIG. 1 are a smoothing capacitor and a battery, respectively. In addition, shown by small solid circles in FIG. 1 are connecting points where electrodes of the individual electric components are electrically and mechanically joined to corresponding parts of a conductor wiring. In this embodiment, the electric components are fixed to the heat sink 17 by nuts and bolts.

FIG. 2 is a plan view of the power unit of the first embodiment showing in particular an exemplary layout of the components of the power unit. It is to be noted that the smoothing capacitor 15 and the battery 16 are not depicted in FIG. 2.

As already mentioned, the main terminals 7, 8, 9 (the N-side terminals 7, the P-side terminals 8 and the rotating-machine-side terminals 9) extend from one side of each of the power modules 6, the three power modules 6 being arranged side by side with the main terminals 7, 8, 9 thereof aligned in one direction and joined to one terminal block 10 and the other three power modules 6 being arranged side by side with the main terminals 7, 8, 9 thereof aligned in the opposite direction and joined to the other terminal block 10. A P-side conductor 10a, an N-side conductor 10b, and rotating-machine-side phase conductors 10cu, 10cv, 10cw connected to the U-, V- and W-phase field coils of the rotating electric machine 11 or 12 are embedded in each of the two terminal blocks 10. The N-side terminals 7 and the P-side terminals 8 are connected to the N-side conductor 10b and the P-side conductor 10a of each terminal block 10, respectively, and the rotating-machine-side terminals 9 of the individual power modules 6 are connected to the corresponding rotating-machine-side phase conductors 10cu, 10cv, 10cw.

The inductor 13 and the power module 14 together constituting the DC-DC converter are also arranged side by side with main terminals thereof aligned in one direction and connected to conductors 18a, 18b, 18c, 18d embedded in a terminal block 18.

While the power unit of the present embodiment includes a total of six power modules 6, the number of the power modules 6 is not necessarily limited to six. If the withstand voltage or current capacity of the power electronic semiconductor devices 1-4 constituting the power modules 6 is insufficient due to large power requirements, for example, a desired number of parallel-connected power modules 6 may be connected to each phase of the rotating electric machines 11, 12 to provide increased withstand voltage and current capacity ratings. Specifically, the number of the power modules 6 mounted on the power unit may be any multiple of three so that each of the three phases is provided with a plurality of power modules 6.

Now, the working of the power unit is described. The DC-DC converter made up of the inductor 13 and the power module 14 connected to the battery 16 stores electric energy when an electric current flows through the inductor 13 with the high-frequency switches 14a held in an ON state. The high-frequency switches 14a of the DC-DC converter are turned on and off by controlling a gate of each high-frequency switch 14a by means of an unillustrated control circuit. When the high-frequency switches 14a are turned off, the electric energy stored in the inductor 13 flows through the power module 14b, producing a voltage increased to a specified level. If the voltage is increased, it is possible to lower the amount of current necessary for feeding the same amount of electric power, thereby reducing the amount of heat loss. This in turn serves to improve efficiency of the power unit (power supply system).

Gates of the IGBTs 1, 3 built in the six power modules 6 for driving the two rotating electric machines 11, 12 are controlled by an unillustrated IGBT control circuit to generate voltages necessary for producing a forward or reverse torque to be applied to the rotating electric machines 11, 12 or for running the rotating electric machines 11, 12 in a forward or reverse direction at a desired speed from the aforementioned increased voltage by using a pulse width modulation (PWM) technique.

While the IGBTs 1, 3 of the individual phases are successively turned on and off by PWM operation, a non-uniform current distribution is likely to occur in a power carrying conductor system of the battery 16. It is however possible to reduce current distortion components and thereby prolong the service life of the battery 16 in this embodiment. This is because the smoothing capacitor 15 is parallel-connected between both electrodes of the battery 16.

The configuration of each of the aforementioned power modules 6 is now described with reference to FIGS. 3, 4A and 4B, in which FIG. 3 is a plan view of each power module 6 incorporated in the power unit, FIG. 4A is a cross-sectional view taken along lines A-A of FIG. 3, and FIG. 4B is a cross-sectional view taken along lines B-B of FIG. 3.

As shown in these Figures, the aforementioned power electronic semiconductor devices (hereinafter referred to as the power electronic semiconductor devices 20) including the IGBTs 1, 3 and the freewheeling diodes 2, 4 have electrodes on top and bottom sides which are affixed to a metal block 22 via respective electrically conductive device bonding layers 21. The electrically conductive device bonding layers 21 are made of an electrically conductive bonding agent, such as a soldering material or silver paste, but not limited to any particular material. The top-side electrodes of the power electronic semiconductor devices 20 are connected to top-side electrode leads 24 via bonding wires 23 made of thin metal wires, for instance, and bottom-side electrode leads 26 of the power electronic semiconductor devices 20 are affixed to the metal block 22 via electrically conductive lead bonding layers 25. Since the bottom-side electrodes and the bottom-side electrode leads 26 of the power electronic semiconductor devices 20 are together joined to the metal block 22, the bottom-side electrodes and the bottom-side electrode leads 26 are interconnected via the metal block 22.

The top-side electrode leads 24 and the bottom-side electrode leads 26 are made of thin metal plates. As illustrated in FIG. 4A, the bottom-side electrode lead 26 corresponds to the N-side terminal 7 of each power module 6, and as illustrated in FIG. 4B, the top-side electrode lead 24 connected to the top-side electrode of the power electronic semiconductor device 20 (freewheeling diode 2) corresponds to the rotating-machine-side terminal 9 of each power module 6.

The individual power electronic semiconductor devices 20 of each power module 6 are packaged by a sealing plastic 27 in such a manner that the sealing plastic 27 covers the metal block 22 and the power electronic semiconductor devices 20 with the top-side electrode leads 24 and the bottom-side electrode lead 26 extending outward.

Since the power electronic semiconductor devices 20 (1-4), which are heat-generating elements, of each power module 6 are disposed above the metal block 22 with the electrically conductive device bonding layers 21 placed in between in the present embodiment, heat generated by the power electronic semiconductor devices 20 is transferred to the metal block 22 through the electrically conductive device bonding layers 21 having a high thermal conductivity. In this structure of the embodiment, heat is transferred from the power electronic semiconductor devices 20 to the metal block 22 without passing through a layer of the sealing plastic 27 having a low thermal conductivity. Thus, a greater amount of heat flows into the metal block 22 per unit time and spreads out in the metal block 22 which provides an enlarged cross-sectional area for heat flux to flow through to the bottom of each power module 6. It is therefore possible to make the power modules 6 featuring excellent heat dissipating performance and compact design as well as high capacity, yet providing economic advantages as it is not necessary to use an expensive sealing plastic material having a high thermal conductivity according to structure of the embodiment.

The above-described power module structure suited for achieving excellent heat dissipating performance and compact design makes it possible to produce the power modules 6 needed for controllably driving the individual phases of the two rotating electric machines 11, 12 in compact size with high reliability.

When any of the power modules 6 fails during the manufacture of the power unit, for instance, it is not necessary to replace all of the power modules 6 but only the faulty power module 6 needs to be replaced in the above-described structure of the embodiment, because the power unit is provided with the discrete power modules 6 for driving the individual phases of the two rotating electric machines 11, 12. This feature of the embodiment makes it possible to reduce the number of components to be replaced and disposed of in case of a failure, thus providing an economic advantage.

Compared to the earlier-mentioned conventional power unit in which six power electronic semiconductor units are packaged in a single power module, the power electronic semiconductor devices 20 are packaged in the six separate power modules 6 in the structure of the present embodiment. This makes it possible to reduce the size of each power module 6 and reduce the potential for the occurrence of deformation or a crack in a plastic case of each power module 6 due to a difference in linear expansion coefficient between different materials of internal conductors and the plastic case. Additionally, the power modules 6 are small-sized and the internal conductors thereof are formed in a relatively simple pattern so that it is easy to fix the conductors at specified positions and perform insert molding operation for manufacturing the power modules 6.

In this embodiment, the main terminals 7, 8, 9 of each power module 6 extend from one side thereof, and three or more power modules 6 are arranged side by side with the individual main terminals 7, 8, 9 aligned in one direction. The N-side terminals 7 and the P-side terminals 8 are connected to the N-side conductor 10b and the P-side conductor 10a of one of two terminal blocks 10, respectively, and the rotating-machine-side terminals 9 of the individual power modules 6 are connected to the corresponding rotating-machine-side phase conductors 10cu, 10cv, 10cw as discussed earlier. As there are provided two separate terminal blocks 10 for connecting input/output lines of the individual power modules 6, the power unit of the embodiment can be structured to provide excellent mechanical durability.

The aforementioned structure of the embodiment is such that the five conductors 10a, 10b, 10cu, 10cv, 10cw are arranged in each of the terminal blocks 10 in an electrically insulated fashion as the conductors 10a, 10b, 10cu, 10cv, 10cw are embedded in grooves formed in an insulator body or molded therein by insert molding, for instance. The P-side conductor 10a, the N-side conductor 10b as well as the rotating-machine-side phase conductors 10cu, 10cv, 10cw connected to the U-, V- and W-phase field coils of one of the rotating electric machines 11, 12 are together formed in this way in each of the terminal blocks 10. Additionally, the conductors 10a, 10b, 10cu, 10cv, 10cw can be laid in generally straight lines. Therefore, the conductors 10a, 10b, 10cu, 10cv, 10cw can be fixed at the specified positions with ease by the insert molding operation, for example, making it possible to manufacture the terminal blocks 10 in a simple and easy way.

Furthermore, even if deformation occurs in the terminal block 10 due to a difference in linear expansion coefficient between the insulator body of the terminal block 10 and the conductors 10a, 10b, 10cu, 10cv, 10cw, minor differences in dimensional changes of these elements (conductors and plastic material) are absorbed by sliding action on boundary surfaces thereof, so that substantially no stress is produced in the individual elements. This helps prevent deformation and cracks in the insulator body, making it possible to manufacture the terminal blocks 10 having excellent mechanical durability and, thus, the power unit having increased mechanical durability.

### Second Embodiment

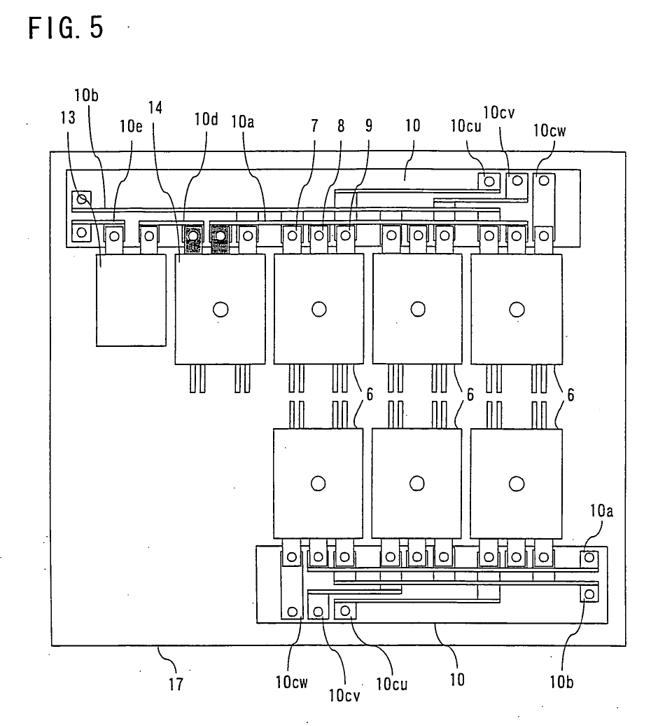

FIG. 5 is a plan view of a power unit according to a second embodiment of the invention. While the inductor 13 and the power module 14 constituting the DC-DC converter are connected to the terminal block 18 provided separately from the terminal blocks 10 to which the power modules 6 are connected in the aforementioned first embodiment, the inductor 13 and the power module 14 are arranged as illustrated in FIG. 5 in the power unit of the second embodiment.

In this embodiment, one of two terminal blocks 10 to which three each power modules 6 are connected is elongated, and the inductor 13 and the power module 14 together constituting a DC-DC converter are connected to the elongated terminal block 10. A P-side conductor 10a, an N-side conductor 10b, three rotating-machine-side phase conductors 10cu, 10cv, 10cw and two conductors 10d, 10e are embedded in this elongated terminal block 10. The inductor 13 and the power module 14 are arranged side by side with main terminals thereof aligned in one direction together with main terminals 7, 8, 9 of the three power modules 6. The N-side terminals 7 and the P-side terminals 8 are connected to the N-side conductor 10b and the P-side conductor 10a of each terminal block 10, respectively, and the main terminals of the inductor 13 and the power module 14 are connected to the two conductors 10d, 10e.

The second embodiment eliminates the need for providing a separate terminal block for connecting the DC-DC converter and thereby simplifies the structure of the power unit while offering the same advantages as the first embodiment.

### Third Embodiment

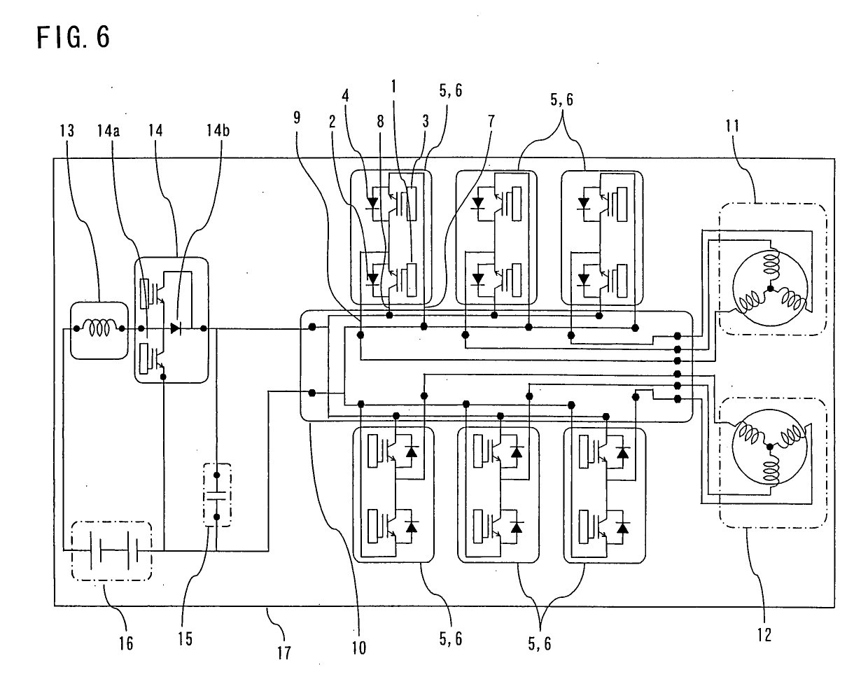

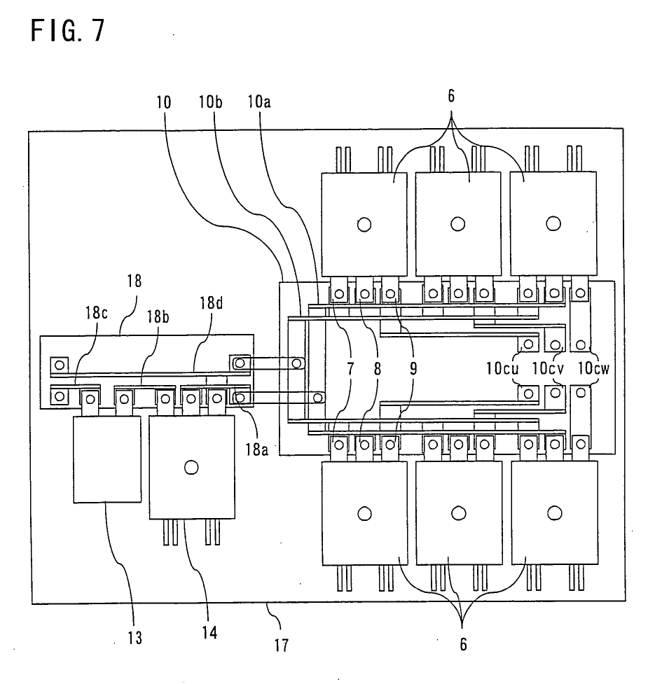

FIG. 6 is a circuit diagram showing an internal circuit configuration of a power unit according to a third embodiment of the invention, and FIG. 7 is a plan view of the power unit of the third embodiment showing in particular an arrangement of constituent components thereof, in which elements equivalent to those of the first embodiment are designated by the same reference numerals.

While the power unit is provided with the two terminal blocks 10 for the rotating electric machines 11, 12 and three each power modules 6 are connected to the individual terminal blocks 10 in the aforementioned first embodiment, the power unit of the third embodiment is provided with only one terminal block 10 and all six power modules 6 are connected to this terminal block 10. As illustrated in FIGS. 6 and 7, three each power modules 6 are arranged side by side on opposite sides of the terminal block 10 such that main terminals 7, 8, 9 of the three each power modules 6 arranged side by side are directed against one side of the terminal block 10.

One pair each of P-side conductors 10a and N-side conductors 10b and three pairs of rotating-machine-side phase conductors 10cu, 10cv and 10cw connected to U-, V- and W-phase field coils of the rotating electric machines 11, 12 are embedded in the terminal block 10. The N-side terminals 7 and the P-side terminals 8 are connected to the N-side conductors 10b and the P-side conductors 10a of the terminal block 10, respectively, and the rotating-machine-side terminals 9 are connected to the corresponding rotating-machine-side phase conductors 10cu, 10cv and 10cw.

The third embodiment makes it possible to connect all the power modules 6 to the single terminal block 10 and thereby simplifies the structure of the power unit while offering the same advantages as the first embodiment.

What is claimed is:

1. A power unit used as a power converter for controllably driving a plurality of rotating electric machines which are switchable between motor mode and generator mode, said power unit comprising:
a plurality of power modules for controlling individual phases of said plurality of rotating electric machines; and
a heat sink on which said power modules are mounted;
each of said power modules including:
a plurality of power electronic semiconductor devices, each having electrodes on top and bottom sides thereof;
a metal block disposed on the bottom side of said power electronic semiconductor devices;
electrically conductive device bonding layers disposed between the bottom-side electrodes of said power electronic semiconductor devices and said metal block in direct contact therewith;
bottom-side electrode leads connected to the bottom-side electrodes of said respective power electronic semiconductor devices;
top-side electrode leads connected to the top-side electrodes of said respective power electronic semiconductor devices; and
a sealing plastic body sealing said metal block and said power electronic semiconductor devices with said bottom-side electrode leads and said top-side electrode leads extending outward from said sealing plastic body.

2. The power unit according to claim 1, wherein at least six power modules are mounted on said heat sink.

3. A power unit used as a power converter for controllably driving a plurality of rotating electric machines which are switchable between motor mode and generator mode, said power unit comprising:
a plurality of power modules for controlling individual phases of said plurality of rotating electric machines, each of said power modules including a plurality of power electronic semiconductor devices;
a heat sink on which said power modules are mounted; and
a terminal block in which conductors are embedded;
wherein at least three of said power modules are arranged side by side with three main terminals of each of said at least three power modules aligned in one direction, and the main terminals of said power modules arranged side by side are connected to the conductors of said terminal block.

4. The power unit according to claim 3, wherein the conductors of said terminal block are a positive-side conductor, a negative-side conductor, and rotating-machine-side phase conductors connected to the individual phases of one of said rotating electric machines.

5. The power unit according to claim 3, wherein at least six power modules are mounted on said heat sink.
